(19) United States
(12) Patent Application Publication
(10) Pub. No.: US 2007/0088990 A1
(43) Pub. Date: Apr. 19, 2007

(54) System and method for reduction of rebuild time in raid systems through implementation of striped hot spare drives

(76) Inventor: Thomas A. Schmitz, Bel Aire, KS (US)

Correspondence Address: LSI LOGIC CORPORATION, 1621 BARBER LANE, MS: D-106, MILPITAS, CA, 95035, US

(21) Appl. No.: 11/252,445

(22) Filed: Oct. 18, 2005

(51) Int. Cl. G11B 20/20

(52) U.S. Cl. 714/700

(57) ABSTRACT

The present invention is a system for reducing rebuild time in a RAID (Redundant Array of Independent Disks) configuration. The system includes a plurality of RAID disk drives, a plurality of hot spare disk drives, and a controller communicatively coupled to the plurality of RAID disk drives and the plurality of hot spare disk drives. The system functions so that rebuild data is striped by the controller across at least two hot spare disk drives included in the plurality of hot spare disk drives.

### FIELD OF THE INVENTION

The present invention relates to the field of electronic data storage and particularly to a system and method for reduction of rebuild time in RAID (Redundant Array of Independent Disks) systems through implementation of striped hot spare drives.

### BACKGROUND OF THE INVENTION

A number of RAID systems currently support the use of hot spare disk drives. A hot spare disk drive is a drive that is in standby mode and is designated for use if a disk drive in a RAID array fails. Upon failure of a disk drive in a RAID array, a RAID controller may automatically begin to “rebuild” the data of the failed disk drive via a rebuild process, which involves reconstructing the data of the failed disk drive using data from one or more of the remaining functional disk drives in the RAID array and writing the reconstructed data (i.e., the rebuild data) to the hot spare disk drive. Once the rebuild process is complete and the failed disk drive is replaced-by a replacement drive, the RAID controller causes the rebuild data to be copied from the hot spare drive back to the replacement drive. The hot spare drive may then return to its previous standby role. Because the rebuild data is being written to a single disk drive (the hot spare drive), the speed of the rebuild process is limited by the write performance of the hot spare drive and/or the bandwidth of the data path from the RAID controller to the hot spare drive.

With current systems, the rebuild process may take hours to complete. This is problematic for a couple of reasons. First, if a disk drive fails and the rebuild process is entered, the RAID array, although still functional, runs in a “degraded” mode for the duration of the rebuild process. This means that the RAID array, due to the failure of the failed disk drive is not operating at peak efficiency or performance during the rebuild process. Further, the RAID array is especially vulnerable during the rebuild process, because, if a second disk drive fails during the rebuild process, the RAID array may be unable to function. Consequently, the RAID controller may be unable to rebuild the data of the failed drives, resulting in the data on the failed drives being lost. Current solutions which attempt to speed up the rebuild time involve implementing a hot spare drive with greater write speed and/or implementing higher bandwidth data paths. However, the current solutions are typically not cost-effective and still produce less than desirable results.

Therefore, it may be desirable to have a system and method for reducing rebuild time in RAID systems which addresses the above-referenced problems and limitations of the current solutions.

### SUMMARY OF THE INVENTION

Accordingly, an embodiment of the present invention is directed to a system for reducing rebuild time in a RAID (Redundant Array of Independent Disks) configuration. The system includes a plurality of RAID disk drives, a plurality of hot spare disk drives, and a controller communicatively coupled to the plurality of RAID disk drives and the plurality of hot spare disk drives. The system functions so that rebuild data is striped by the controller across at least two hot spare disk drives included in the plurality of hot spare disk drives.

A further embodiment of the present invention is directed to a method for reducing rebuild time in a RAID (Redundant Array of Independent Disks) system. The method includes providing a plurality of hot spare disk drives; reconstructing data of a failed disk drive of the RAID system, the reconstructed data being rebuild data; and striping the rebuild data across at least two hot spare disk drives included in the plurality of hot spare disk drives.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a prior art RAID (Redundant Array of Independent Disks) system implementing a hot spare disk drive;

FIG. 2 is an illustration of a system for reducing rebuild time in a RAID (Redundant Array of Independent Disks) configuration in accordance with an exemplary embodiment of the present invention;

FIG. 3 is an illustration of a system for reducing rebuild time in a RAID (Redundant Array of Independent Disks) configuration in accordance with an exemplary embodiment of the present invention; and

FIG. 4 is an illustration of a method for reducing rebuild time in a RAID (Redundant Array of Independent Disks) system in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

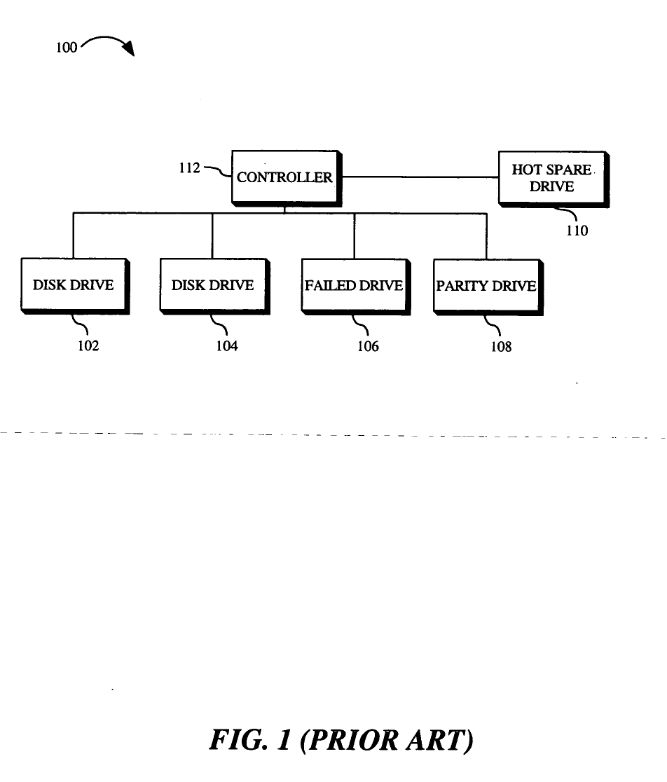

FIG. 1 illustrates a typical RAID (Redundant Array of Independent Disks) configuration 100. Included in the configuration are a plurality of RAID disk drives (102, 104, 106 and 108). One of the RAID disk drives 108 is a dedicated parity drive (generally used in RAID 3 configurations). The dedicated parity drive 108 contains parity information which allows for data recovery/reconstruction if one of the RAID disk drives (102, 104 or 106) fails. Also included in the above-referenced configuration is a hot spare disk drive 110. A hot spare disk drive 110 is a disk drive that is called into use, typically by a RAID controller 112, upon the failure of one of the RAID disk drives. In the RAID configuration illustrated in FIG. 1, one of the RAID disk drives 106 has failed. Upon failure of the RAID disk drive 106, the hot spare disk drive 110 may be automatically prompted by a RAID controller to begin receiving rebuild data that has been reconstructed for the failed disk drive 106 by the controller using data from disk drives 102, 104, and 108. For instance, during the rebuild process, the RAID controller, using data obtained from the parity drive 108 performs a series of complex algorithms and calculations that determine what data needs to be rebuilt/reconstructed (i.e., the rebuild data). The rebuild data is then written to the hot spare disk drive 110. Once the failed disk drive 106 is replaced by a replacement disk drive, the controller reads the rebuild data from the hot spare disk drive 110 and copies it to the replacement disk drive. The hot spare disk drive 110 is then able to return to a standby role, until another RAID disk drive fails. Further, the replacement disk drive proceeds to operate normally within the RAID configuration 100, taking the place of failed disk drive 106.

One of the problems of the typical RAID configuration illustrated in FIG. 1 is that it only employs a single hot spare disk drive 110. As a result, when rebuild data needs to be written to the hot spare disk drive by the RAID controller, the speed at which this process occurs is dependent upon the write performance of the hot spare disk drive 110 and/or the bandwidth of the data path from the controller to the hot spare disk drive 110. Unfortunately, the rebuild process in current RAID configurations, as shown in FIG. 1, can be somewhat slow (several hours in duration). This slow rebuild time creates a non-redundant failure window for the RAID configuration being rebuilt/reconstructed. Since most RAID configurations generally cannot remain functional with two failed RAID disk drives in an array (an exception being a RAID 6 configuration), if a second RAID disk drive, such as the parity drive 108, were to fail during the rebuild process, it may not be possible to rebuild the data of the RAID configuration/volume 100 and said data may be lost.

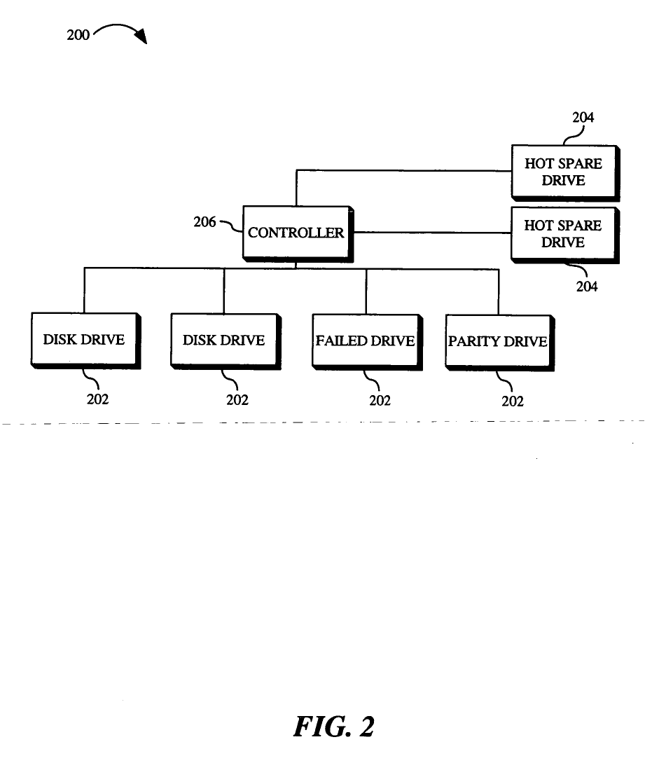

FIG. 2 illustrates a system 200 in accordance with an exemplary embodiment of the present invention. In a present embodiment, the system 200 includes a plurality of RAID disk drives 202 and a plurality of hot spare disk drives 204. Further included is a controller 206, such as a RAID controller, communicatively coupled to the plurality of RAID disk drives 202 and the plurality of hot spare disk drives 204. It is contemplated that alternative embodiments of the system 200 of the present invention may include a plurality of controllers 206. In FIG. 2, one of the plurality of RAID disk drives 202 has failed. In the illustrated embodiment, data of a failed RAID disk drive 202 is rebuilt by the controller 206 (i.e., rebuild data). The controller 206 may rebuild the data by using data from one or more of the remaining functional disk drives of the plurality of disk drives 202 and by performing normal RAID algorithm(s) for rebuild, said algorithm(s) being currently known in the art. The rebuild data is then striped by the controller 206 across at least two hot spare disk drives 204 included in the plurality of hot spare disk drives. Once the failed disk drive is replaced, the controller 206 may read the rebuild data from the at least two hot spare disk drives 204 and copy the rebuild data to the replacement disk drive. By striping the rebuild data across multiple hot spare disk drives 204 (as in the present invention, and as shown in FIG. 2) rather than writing the rebuild data to a single hot spare disk drive (as with current systems, as shown in FIG. 1), the system 200 of the present invention may decrease rebuild time by increasing the write/read bandwidth to/from the hot spare disk drives 204. By decreasing the rebuild time, the possibility of data loss-occurring due to a second RAID disk drive failing during the rebuild process is reduced. In current embodiments, as shown in FIG. 2, the at least two hot spare disk drives may be dedicated to a single RAID array.

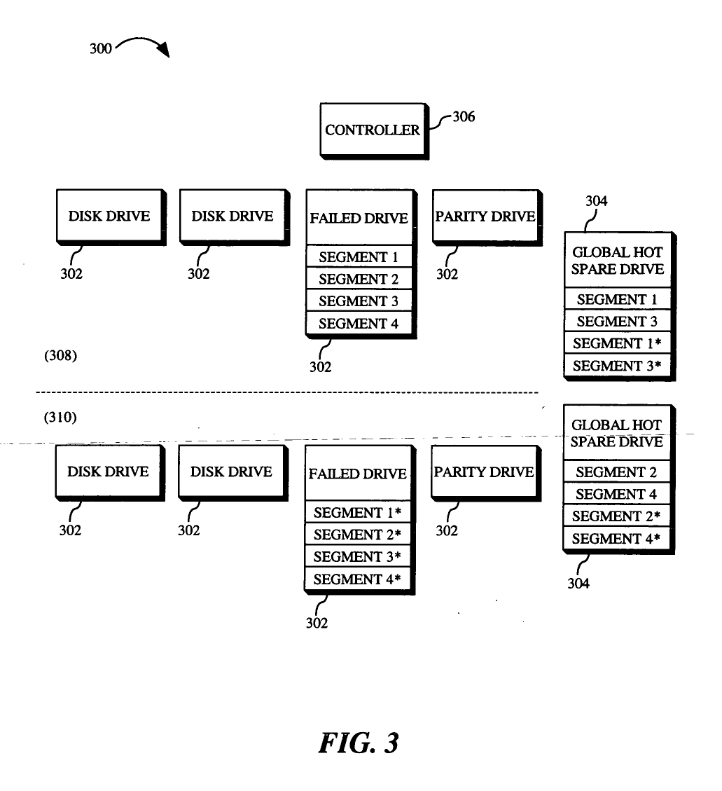

FIG. 3 illustrates a system 300 in accordance with another exemplary embodiment of the invention in which global hot spare disk drives, rather than hot spare disk drives, are implemented. In the illustrated embodiment, the system 300 includes a plurality of RAID disk drives 302 and a plurality of global hot spare disk drives 304. Further included is a controller 306 communicatively coupled to the plurality of RAID disk drives 302 and the plurality of global hot spare disk drives 304. It is contemplated that alternative embodiments of the system 300 of the present invention may include a plurality of controllers 306. In FIG. 3, a system is shown in which the plurality of RAID disk drives 302 are distributed over multiple RAID arrays (i.e., drive groups) 308 and 310. In current embodiments, the global hot spare disk drives 304 are shared by the multiple RAID arrays (308, 310), meaning that either global hot spare disk drive 304 can store data from a failed disk drive 302 in any of the multiple RAID arrays (see exemplary segment allocation in FIG. 3). In FIG. 3, one RAID disk drive 302 in each RAID array (308, 310) has failed. In the illustrated embodiment, data for the failed RAID disk drives 302 is rebuilt by the controller 306 (i.e., rebuild data). The controller 306 may rebuild the data using data from one or more of the remaining functional disk drives of the plurality of RAID disk drives 302, and by performing normal RAID algorithm(s) for rebuild, said algorithm(s) being currently known in the art. The rebuild data is then striped by the controller 306 across at least two global hot spare disk drives 304 included in the plurality of global hot spare disk drives. When the failed RAID disk drives 302 have been replaced, the controller 306 may then read the rebuild data from the global hot spare disk drives 304 and copy the rebuild data to the replacement RAID disk drives. The global hot spare disk drives 304 may then return to standby mode, until another RAID disk drive failure occurs.

By striping the rebuild data across the multiple global hot spare disk drives 304 (as in the present invention, and as shown in FIG. 3) rather than writing the rebuild data to a single global hot spare disk drive (as with current systems), the system 300 of the present invention may decrease rebuild time by increasing the write/read bandwidth to/from the global hot spare disk drives 304. By decreasing the rebuild time, the possibility of data loss occurring due to a second RAID disk drive failing during the rebuild process is reduced.

Further, as shown in FIG. 3, the rebuild data may be striped at the segment size level. In exemplary embodiments, segment size may be varied by a user. In additional embodiments, stripe width may be varied by a user, such as by increasing the number of hot spare/global hot spare disk drives used. For instance, if rebuild data is being striped across two hot spare disk drives and a third hot spare disk drive is added, the system may then be configured to stripe the same rebuild data across the three hot spare disk drives for increasing bandwidth, I/O (input/output) efficiency to and from the hot spare disk drives, which may result in a decrease in rebuild time (which includes time spent by the controller writing/reading rebuild data to/from the hot spare/global hot spare disk drives).

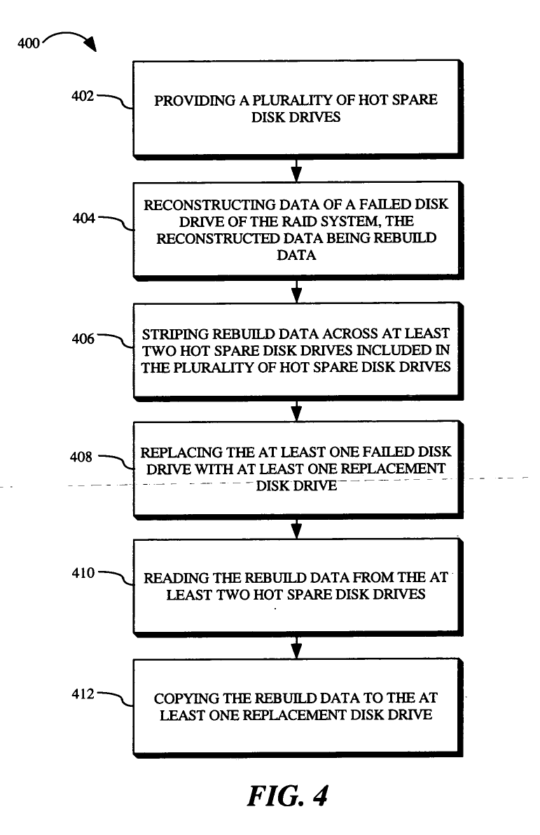

FIG. 4 is a flowchart illustrating a method for reducing rebuild time in a RAID (Redundant Array of Independent Disks) system in accordance with an embodiment of the present invention. The method 400 includes the step of providing a plurality of hot spare disk drives 402. The method further includes the step of reconstructing data of a failed disk drive of the RAID system, the reconstructed data being rebuild data 404. The method 400 further includes the step of striping the rebuild data across at least two hot spare disk drives included in the plurality of hot spare disk drives 406. In current embodiments, the rebuild data is reconstructed using data stored on at least one remaining functional disk drive of the RAID system. In further embodiments, the method 400 further includes the step of replacing the at least one failed disk drive with at least one replacement disk drive 408. In additional embodiments, the method 400 further includes the step of reading the rebuild data from the at least two hot spare disk drives 410. In still further embodiments, the method 400 includes the step of copying the rebuild data to the at least one replacement disk drive 412. It is to be understood that the above described method 400 for reducing rebuild time in a RAID system may be adapted to any RAID system that supports hot spare disk drives, such as RAID 1, 3, 5 (distributed parity), (0+1), etc.

The system/method of the present invention may be implemented with existing systems. For example, a number of current RAID systems include two or more hot spare/global hot spare disk drives (typically done if the RAID system includes a relatively large number of RAID disk drives). However, in the current systems, the hot spare/global hot spare disk drives are used individually. For example, when a RAID disk drive fails in a current system, the entire reconstructed contents of that failed disk are written by the controller to a single hot spare disk drive. As a result, even if a second hot spare disk drive is available, the second hot spare disk drive is not utilized, and remains idle, until a second disk drive fails. Consequently, the rebuild time is longer with conventional RAID systems, than with the present invention, which expands bandwidth, input/output (1/O) capabilities of the multiple hot spare drives by utilizing multiple hot spare drives in a more efficient, parallel fashion (via striping). Therefore, the present invention may be easily adapted to current systems already having multiple hot spare/global hot spare disk drives by modifying the current system(s) so that the multiple hot spare/global hot spare disk drives store rebuild data for a failed disk drive in a striped manner, as in the present invention. This may also be cost-efficient in that it may not be necessary to add any new hardware (i.e., hot spare/global hot spare disk drives) to the current system(s) in order to implement the system/method of the present invention. Moreover, in those current systems with only a single hot spare/global hot spare disk drive, additional hot spare/global hot spare disk drives may be easily added to implement the system/method of the present invention.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention maybe conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A system for reducing rebuild time in a RAID (Redundant Array of Independent Disks) configuration, comprising:
a plurality of RAID disk drives;
a plurality of hot spare disk drives; and
a controller communicatively coupled to the plurality of RAID disk drives and the plurality of hot spare disk drives,
wherein rebuild data is striped by the controller across at least two hot spare disk drives included in the plurality of hot spare disk drives.

2. A system as claimed in claim 1, wherein the at least two hot spare disk drives included in the plurality of hot spare disk drives are global hot spare disk drives.

3. A system as claimed in claim 2, wherein the global hot spare disk drives are shared by more than one RAID array of the RAID system.

4. A system as claimed in claim 1, wherein the rebuild data is reconstructed data of a failed disk drive in the plurality of RAID disk drives.

5. A system as claimed in claim 4, wherein the rebuild data has been reconstructed using data from at least one remaining functional disk drive in the plurality of RAID disk drives.

6. A system as claimed in claim 1, wherein the rebuild data is striped at a segment size level.

7. A system as claimed in claim 1, wherein the rebuild data that is striped to the hot spare disk drives has a variable stripe width.

8. A method for reducing rebuild time in a RAID (Redundant Array of Independent Disks) system, comprising:
providing a plurality of hot spare disk drives;
reconstructing data of a failed disk drive of the RAID system, the reconstructed data being rebuild data; and
striping the rebuild data across at least two hot spare disk drives included in the plurality of hot spare disk drives.

9. A method as claimed in claim 8, further comprising:
replacing the at least one failed disk drive with at least one replacement disk drive.

10. A method as claimed in claim 9, further comprising:
reading the rebuild data from the at least two hot spare disk drives.

11. A method as claimed in claim 10, further comprising:
copying the rebuild data to the at least one replacement disk drive.

12. A method as claimed in claim 8, wherein striping is performed by a RAID controller.

13. A method as claimed in claim 8, wherein the hot spare disk drives are global hot spare disk drives.

14. A method as claimed in claim 13, wherein the global hot spare disk drives are shared by more than one RAID array of the RAID system.

15. A method as claimed in claim 8, wherein the rebuild data is reconstructed using data stored on at least one remaining functional disk drive of the RAID system.

16. A method as claimed in claim 8, wherein the rebuild data is striped to the hot spare disk drives at a segment size level.

17. A system for reducing rebuild time in a RAID (Redundant Array of Independent Disks) configuration, comprising:
means for providing a plurality of hot spare disk drives;
means for reconstructing data of a failed disk drive of the RAID system, the reconstructed data being rebuild data; and
means for striping the rebuild data across at least two hot spare disk drives included in the plurality of hot spare disk drives.

18. A system as claimed in claim 17, further comprising:
means for replacing the at least one failed disk drive with at least one replacement disk drive.

19. A system as claimed in claim 18, further comprising:
means for reading the rebuild data from the at least two hot spare disk drives.

20. A system as claimed in claim 49; further comprising:
means for copying the rebuild data to the at least one replacement disk drive.
